(19) United States
(12) Patent Application Publication
(10) Pub. No.: US 2002/0129061 A1
(43) Pub. Date: Sep. 12, 2002

(54) Method and apparatus for creating files that are suitable for hardcopy printing and for on-line use

(76) Inventors: Stacey J. Swart, Fort Collins, CO (US); Meredith D. Mathews, Loveland, CO (US); Paul M. Loughlin, Fort Collins, CO (US)

Correspondence Address: HEWLETT-PACKARD COMPANY, Intellectual Property Administration, P.O. Box 272400, Fort Collins, CO, 80527-2400, US

(21) Appl. No.: 09/800,648

(22) Filed: Mar. 7, 2001

(51) Int. Cl. G06F 17/21

(52) U.S. Cl. 707/513

(57) ABSTRACT

An apparatus and a method are provided for generating files that can be printed as hardcopy documents and that can be conveniently converted into files that are suitable for on-line use. First logic configured to perform a technical writing tool algorithm receives input describing a particular format and a content that a document is to have and processes the input to generate a first markup language file. The first markup language file is printable as a hardcopy printed document, if desired, and includes first markup language formatting information. Second logic receives the first markup language file and performs a conversion algorithm that converts the first markup language file into a second markup language file. The second markup language file includes second markup language formatting information that describes an on-line format and an on-line content that the document is to have when it is placed on-line.

### TECHNICAL FIELD OF THE INVENTION

The present invention generally relates to a method and an apparatus for generating files and more specifically to a method and apparatus for generating files that are suitable for hardcopy printing and that can be converted into markup language files that are suitable for on-line use.

### BACKGROUND OF THE INVENTION

Companies often have a need to generate printable (hardcopy) documentation relating to their product lines that can be supplied to consumers as well as have corresponding documentation that is in an electronic format (e.g., documentation that can be placed on-line on web sites (e.g., on the Internet)). It is undesirable, for obvious reasons, to expend company resources to recreate documentation for placement on-line when corresponding printed hardcopy documentation has already been created for physical distribution to consumers. One attempt at avoiding this waste of resources in demonstrated pictorially in FIG. 1. Specifically, a technical writing tool software program 1 running on a computer 2 is used to generate text and/or graphics files in the form of both printable and on-line portable document format (PDF) files 3 and 4, respectively.

By way of explanation, PDF is a file format that represents documents in a manner that is independent of the original application software, hardware, and operating system used to create those documents. A PDF file can describe documents containing and combination of text, graphics, and images in a device-independent and resolution-independent format. PDF files can be printed to and stored on CD-ROM, and they can be modified to look like on-line web documents (e.g., Internet web pages). However, in order to modify the on-line PDF files of FIG. 1 to make them viewable as, for example, Internet web pages, a considerable amount of effort is often required on the part of the person in charge of performing this task.

Moreover, although files can be created in a form that is suitable for on-line use by writing the document in electronic form as a hypertext markup language (HTML) document, the HTML format is generally not preserved when the hardcopy document is printed. Therefore, this is also not a suitable solution to the problem of duplicating documentation, especially in cases where it is desirable to have the same type of formatting for the printed and on-line documentation.

### SUMMARY OF THE INVENTION

Accordingly, a need exists for one to be able to generate documents that are suitable for hardcopy printing and that can be converted into markup language files that are suitable for on-line use. The present invention provides an apparatus and a method for generating files that can be printed as hardcopy documents and that can be converted into files that are suitable for on-line use. First logic configured to perform a technical writing tool algorithm receives input describing a particular format and a content that a document is to have and processes the input to generate a first markup language file. The first markup language file can be printed as a printed document, if desired, and includes first markup language formatting information. Second logic receives the first markup language file and performs a conversion algorithm that converts the first markup language file into a second markup language file. The second markup language file includes second markup language formatting information that describes an on-line format and an on-line content that the document is to have when it is placed on-line.

These and other features and advantages of the present invention will become apparent from the following discussion, drawings and claims.

### BRIEF DESCRIPTION OF THE DRAWINGS

FIG. 1 is a pictorial representation of the prior art technique for creating documents using a technical writing tool that enables the documents to be printed and placed on-line in a non-HTML format.

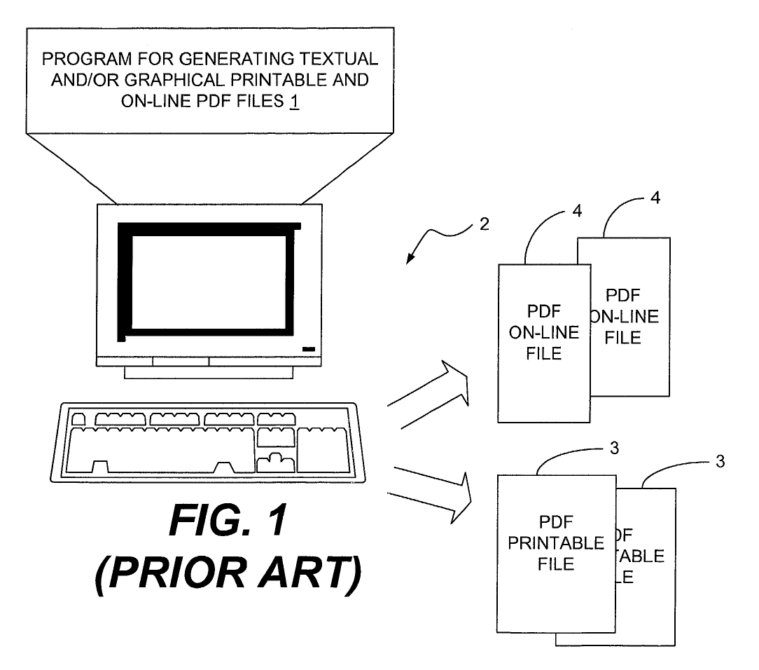

FIG. 2 is a block diagram illustrating the method and apparatus of the present invention in accordance with a first embodiment, wherein manually-stylized SGML files created using a technical writing tool are convertible into HTML files.

FIG. 3 is a block diagram illustrating the method and apparatus of the present invention in accordance with another embodiment, wherein style templates associated SGML files created using the technical writing tool shown in FIG. 2 have been mapped into styles that are native to a markup language conversion tool to enable the SGML files to be easily and automatically convertible into HTML files.

FIG. 4 is a flow chart illustrating the method of the present invention in accordance with one embodiment.

### DETAILED DESCRIPTION OF THE INVENTION

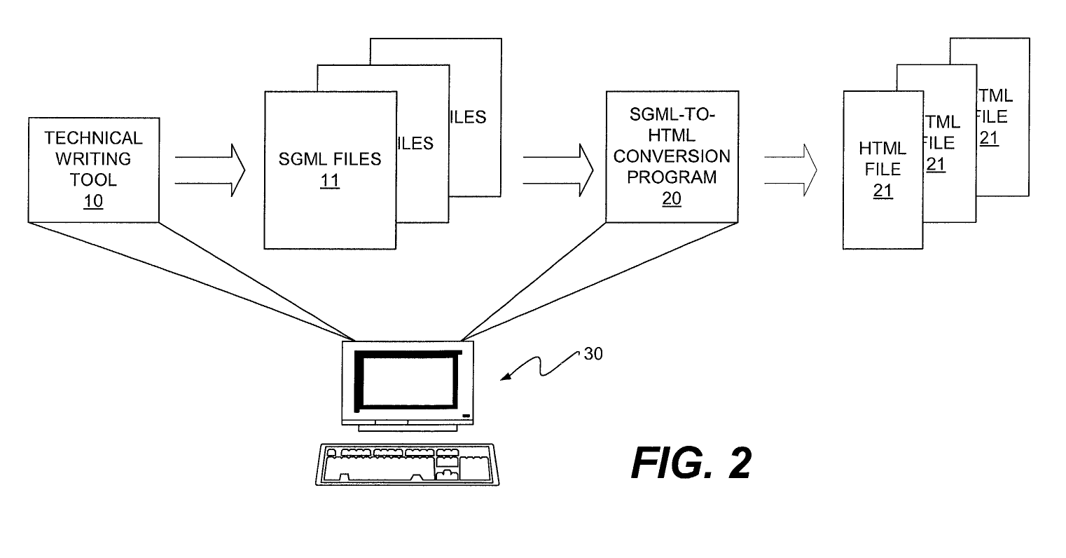

FIG. 2 is a block diagram illustrating the apparatus of the present invention in accordance with one embodiment. The apparatus comprises a technical writing tool 10 that is capable of being configured to generate a Standard Generalized Markup Language (SGML) and a conversion tool 20 capable of being configured to convert an SGML file into an HTML file. A suitable technical writing tool 10 for this purpose is Adobe® FrameMaker+SGML. It should be understood that tool 10 may also be logic that performs a technical writing algorithm or could also be a device for technical writing. A suitable SGML-to-HTML conversion tool 20 for this purpose is Web®Works Publisher Professional marketed by Quadralay Corporation. Both of these tools 10 and 20 are software computer programs running on a computer 30. The Adobe® FrameMaker+SGML program is capable of generating PDF files and can be configured to generate Standard Generalized Markup Language (SGML) files.

In accordance with the embodiment of the present invention shown in FIG. 2, the technical writing tool 10 is configured to receive input that has been input to the computer 30 and to generate SGML files 11. The SGML files 11 are suitable for hardcopy printing and they can be converted into HTML files 21. The HTML files 21 can then be used on-line. For example, they can used to generate electronic documents, such as web pages, or electronic documents accessible and viewable on a web page. With respect to the printed SGML files 11, the underlying SGML code (not shown) is hidden when printed and therefore is not visible. In accordance with the present invention, it was determined through research and investigation that the Adobe® FrameMaker+SGML program (hereinafter referred to as “FrameMaker”) and the Quadralay WebWorks® Publisher Professional program (hereinafter referred to as “WebWorks”) are compatible with each other because of the ability of FrameMaker to be configured to generate SGML files and because of the ability of WebWorks to receive SGML files and convert them into HTML files.

A file known as an element definition document (EDD) file can be created in FrameMaker. This file contains elements and their definitions and structures. In order for FrameMaker to generate an SGML file, an EDD file must be configured, which gives the SGML file its structure. The elements defined in the FrameMaker EDD file, such as paragraphs, lists of items, etc., have styles associated with them. Because all of the FrameMaker styles currently do not map exactly to styles in WebWorks and WebWorks does not utilize elements, in accordance with the embodiment shown in FIG. 2, some manual formatting of the HTML file 21 produced by WebWorks may be required in order for the HTML file 21 to have a look that is consistent with the style and formatting of the SGML file 11, especially if it is desirable to produce HTML documents that always have consistent formats. Those skilled in the art will understand, in view of the discussion provided herein, the manner in which these manual formatting tasks can be accomplished.

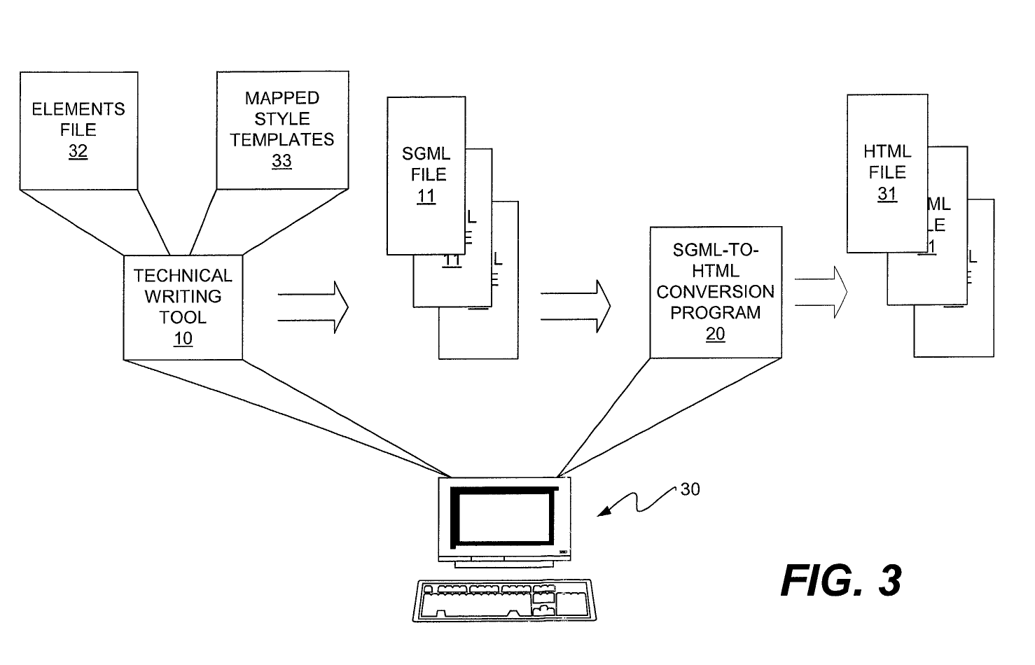

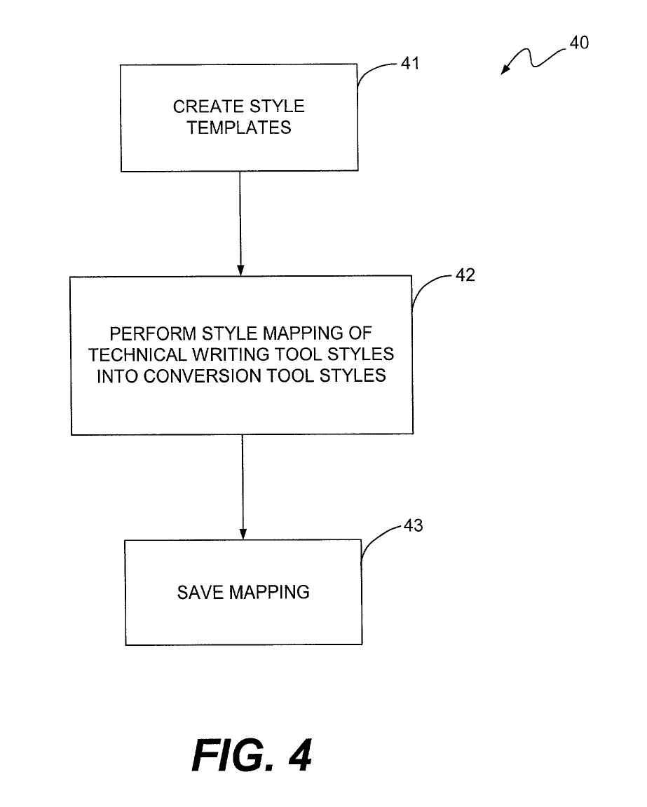

FIG. 3 represents the apparatus of the present invention in accordance with another embodiment. Specifically, the styles associated with the elements of the technical writing tool 10, hereinafter referred to as FrameMaker for purposes of demonstrating an example embodiment, are maintained separately from the elements, the element structures and the definitions of the elements. The elements, the element structures and the element definitions are maintained in the EDD file 32. Each of the FrameMaker elements has one or more styles associated with it. In accordance with the present invention, the FrameMaker elements' styles are not associated with the elements in the EDD file, but rather, are located in style templates 33. In accordance with the present invention, it was determined that if the SGML files 11 are not formatted consistently, the HTML files 21 produced by the conversion tool 20, hereinafter referred to as WebWorks for purposes of demonstrating the example embodiment, may not have a look that is consistent with the SGML files 11. This is because some elements defined in the EDD file may not even be carried over by WebWorks when the conversion into HTML is performed and because FrameMaker styles do not map exactly to WebWorks styles. Therefore, a style-mapping process is used by the apparatus shown in FIG. 3 to ensure that WebWorks knows which WebWorks styles to use. The style-mapping process is discussed below with reference to FIG. 4. This embodiment ensures that no manual formatting of the output HTML file 31 will be required.

FIG. 4 is a flow chart illustrating the style-mapping process 40 of the present invention performed by the apparatus shown in FIG. 3. In accordance with this embodiment, the FrameMaker styles have been organized into style templates and thus are separate from the elements, the element definitions, and the element structures, as indicated by block 41. Generally, for a style applied in FrameMaker, WebWorks needs to be told what that style corresponds to in WebWorks. For each style being used in FrameMaker that does not have a counterpart style in WebWorks, or that does not map exactly to a style in WebWorks, the associated WebWorks style is modified to behave in the same manner as the associated style in FrameMaker. This style-mapping process is represented by block 42. Once the FrameMaker style templates have been mapped, the mapping is saved, as indicated by block 43. Therefore, each time an SGML document is created by the technical writing tool 10 and output to the conversion tool 20, the conversion tool 20 will automatically recognize the FrameMaker style templates and use the same style formats for the FrameMaker elements when the conversion into HTML is performed.

In order to keep document formatting consistent and prevent inaccurate HTML output documents from being generated, the EDD file and the style templates should not be modified. Modification of the EDD file and/or the style templates will generally result in format changes in all of the HTML documents generated. However, the EDD file and the style templates may be modified and there will be occasions when they should be modified. For example, a particular company utilizing the present invention may desire that its documentation have a consistent style and format, but may later want to change the style and/or format. The one-time style-mapping process enables the company's documentation to have a consistent style and format, but also enables that style and format to be changed to a different, yet consistent, style and format.

Since the style formats have been placed in style templates, the style formats for the elements can be easily located and modified if necessary. Likewise, the element definitions and structures can be easily located in the EDD file and modified. The style-mapping process enables WebWorks to detect these modifications and consistently and accurately generate the correct HTML document. This is also useful when, for example, a document prepared with formatting suitable for one language, such as English, needs to be formatted differently to make it suitable for another language, such as German. Part of the definition of a note element comprised in the EDD file may be, for example, that the word “Note” appears in English in the SGML document (and, consequently, in the HTML document). Due to the organization of the EDD file provided via the present invention, the note definition can be easily modified in the EDD file so that the spelling of the word “Note” appears in German rather than in English. Similarly, a style, such as the indentation of a paragraph, can be easily modified. The style-mapping procedure enables WebWorks to determine the style to be applied to the element in various situations, such as when a paragraph constitutes the introduction to a chapter or, instead, when the paragraph appears within a list.

It should be noted that although the present invention has been described with reference to particular embodiments, the present invention is not limited to these embodiments. Those skilled in the art will understand that modifications may be made to the embodiments discussed above that are within the scope of the present invention. For example, although the present invention has been discussed with respect to utilizing a particular technical writing tool to generate and SGML file, those skilled in the art will understand that there may be other technical writing tools available that generate SGML files or other markup language files that therefore are suitable for use with the present invention.

Also, WebWorks is capable of accepting as its input other markup language files, such as Extensible Markup Language (XML) files. Therefore, a technical writing tool that is capable of generating an XML file that is suitable for use by the present invention would also be within the scope of the invention. Also, although the present invention has been described with respect to a particular conversion tool, those skilled in the art will understand that other conversion tools may also be suitable for use with the present invention. In addition, although element-mapping could be used instead or in addition to style-mapping to achieve the goals of the present invention, style mapping was utilized in the example embodiment discussed above with reference to FIGS. 3 and 4. Those skilled in the will understand the manner in which such modifications can be made to the embodiments discussed above and that such modifications are within the scope of the present invention.

What is claimed is:

1. An apparatus for generating files, the apparatus comprising:
a first logic configured to perform a technical writing tool algorithm, the technical writing tool algorithm for receiving input describing a particular selected format and content for a document, the technical writing tool algorithm for processing said input to generate a first markup language file, wherein said first markup language file is printable as a hardcopy document, said first markup language file including first markup language formatting information; and
a second logic configured to receive the first markup language file and to perform a conversion algorithm that converts the first markup language file into a second markup language file, wherein said second markup language file includes a second markup language formatting information describing a particular on-line format and content of said document.

2. The apparatus of claim 1, wherein said input describing said particular format includes style information that describes a style that document elements are to have if the first markup language file is printed.

3. The apparatus of claim 1, wherein said input describing said particular format includes style information that describes a style that document elements are to have if the second markup language file is placed on-line.

4. The apparatus of claim 1, wherein said first markup language is a Standard Generalized Markup Language (SGML).

5. The apparatus of claim 1, wherein said second markup language is a Hypertext Markup Language (HTML).

6. The apparatus of claim 1, wherein said technical writing tool algorithm is a computer program known as Adobe® FrameMaker+SGML.

7. The apparatus of claim 1, wherein said conversion algorithm is a computer program known as WebWorks® Publisher Professional.

8. The apparatus of claim 1, wherein said first markup language is a Standard Generalized Markup Language (SGML) and wherein said second markup language is a Hypertext Markup Language (HTML).

9. The apparatus of claim 8, wherein said first logic is pre-configured to map styles native to said technical writing tool algorithm to styles native to said conversion algorithm, and wherein said first markup language formatting information includes information relating to said styles native to said conversion algorithm.

10. A method for generating files, the method comprising:
processing input describing a particular desired format and content for a document to generate a first markup language file, wherein said first markup language file is printable as a hardcopy document, said first markup language file including first markup language formatting information; and
converting the first markup language file into a second markup language file, wherein said second markup language file includes second markup language formatting information that describes a particular on-line format and content of said document when it is placed on-line.

11. The method of claim 10, wherein said input describing said particular format includes style information that describes a style that document elements are to have if the first markup language file is printed.

12. The method of claim 10, wherein said input describing said particular format includes style information that describes a style that document elements are to have if the second markup language file is placed on-line.

13. The method of claim 10, wherein said first markup language is a Standard Generalized Markup Language (SGML).

14. The method of claim 10, wherein said second markup language is a Hypertext Markup Language (HTML).

15. The method of claim 10, wherein the processing step is performed by a technical writing tool software program being executed on a computer, wherein said technical writing tool program is Adobe® FrameMaker+SGML.

16. The method of claim 10, wherein the step of converting is performed by conversion software program being executed on a computer, wherein the conversion software program is WebWorks® Publisher Professional.

17. The method of claim 16, wherein said first markup language is a Standard Generalized Markup Language (SGML) and wherein said second markup language is a Hypertext Markup Language (HTML).

18. The method of claim 10, wherein the processing step is performed by a technical writing tool software program being executed on a computer, and wherein the step of converting is performed by conversion software program being executed on a computer, and wherein prior to the processing step, a pre-configuration step is performed, said pre-configuration step comprising:
mapping styles native to said technical writing tool software program to styles native to said conversion software program, and wherein said first markup language formatting information includes information relating to said styles native to said conversion software program.

19. The method of claim 18, wherein said first markup language is a Standard Generalized Markup Language (SGML) and wherein said second markup language is a Hypertext Markup Language (HTML).

20. A computer program for generating files, the computer program embodied on a computer-readable medium, the computer program comprising:
a first algorithm, the first algorithm processing input describing a particular desired format and a content for a document to generate a first markup language file, wherein said first markup language file is printable as a hardcopy document, said first markup language file including first markup language formatting information; and
a second algorithm, the second algorithm converting the first markup language file into a second markup language file, wherein said second markup language file includes second markup language formatting information that describes a particular on-line format and content of said document when it is placed on-line.
